(19) United States
(12) Patent Application Publication
(10) Pub. No.: US 2026/0235352 A1
(43) Pub. Date: Aug. 13, 2026

(54) COMPACT CARBON DIOXIDE CAPTURE AND LIQUEFACTION SYSTEM USING HIGH-TEMPERATURE DISTRICT HEATING WATER WASTE HEAT FROM URBAN POWER PLANT COMBUSTION EXHAUST GAS

(71) Applicant: Korea District Heating Corp., Gyeonggi-do (KR)

(72) Inventors: Won Seok CHANG, Gyeonggi-do (KR); Kyoung A. SHIN, Gyeonggi-do (KR); Me Hee JANG, Seoul (KR); Jin Soo OH, Gyeonggi-do (KR); Jong Jun LEE, Gyeonggi-do (KR); Kyung Min KIM, Gyeonggi-do (KR); Hyeong Gyu NAMGUNG, Gyeonggi-do (KR); Jae Yong SHIN, Gyeonggi-do (KR); Ji Hye YU, Incheon (KR); Joong Yong YI, Seoul (KR); Hoon KIM, Gyeonggi-do (KR)

(21) Appl. No.: 19/155,141

(22) PCT Filed: Jun. 9, 2023
(86) PCT No.: PCT/KR2023/007924

§ 371 Date: Aug. 8, 2025

(30) Foreign Application Priority Data
Feb. 10, 2023 (KR) 10-2023-0017834

(51) Int. Cl. F25J 1/02; B01D 53/00; F25J 1/00

(52) U.S. Cl. CPC F25J 1/0242; B01D 53/00; F25J 1/0027; F25J 1/0225; B01D 2257/504; B01D 2259/65; F25J 2260/02

(57) ABSTRACT

A compact carbon dioxide capture and liquefaction system using high-temperature district heating water waste heat from urban power plant combustion exhaust gas may include: a heat storage tank supplied with and storing district heating water heated in a combined heat and power plant; an absorption chiller that recovers waste heat by exchanging heat with the district heating water supplied to the heat storage tank and then supplies the district heating water to the heat storage tank; a first cooler into which exhaust gas discharged from the combined heat and power plant flows and in which heat is exchanged between the exhaust gas and the cooling water supplied from the absorption chiller; and a capture device into which the exhaust gas discharged from the first cooler flows and which captures carbon dioxide contained in the exhaust gas; and a liquefaction device which liquefies the carbon dioxide captured in the capture device.

### TECHNICAL FIELD

The present invention relates to a compact carbon dioxide capture and liquefaction system using high-temperature district heating water waste heat with respect to combustion exhaust gas of an urban power plant when effectively treating components of carbon dioxide within the combustion exhaust gas of the urban power plant through a compact capture process and liquefaction process of a gas separation membrane.

### BACKGROUND ART

In order to solve the problems of conventional carbon capture and storage (CCS) technology that requires a larger area within a power plant and incurs high treatment costs, a new carbon resource technology with commercial viability in which carbon dioxide capture and separation that is compact and effective even in the narrow space of a liquefied natural gas (LNG) power plant located in the city center, is achieved by concentrating carbon dioxide using a membrane process and converting the concentrated carbon dioxide into high-priced substances (liquefied carbon dioxide, calcium carbonate, etc.) through post-treatment is needed, and in particular, the concentration of carbon dioxide is low as 4~5% of exhaust gas of the LNG power plant, while the concentration of oxygen is high as 12% thereof, making it difficult to treat the exhaust gas using conventional absorption methods.

When exhaust gas of a plant is rapidly treated (5 times faster than the conventional case) and effectively treated with low cost (½ compared to the conventional case) using a compact membrane process that can be installed even in a narrow space (⅛ compared to the conventional case), the concentration of carbon dioxide may be concentrated from 4~5% before treatment to 80~90% after treatment, and then profits may be made by producing high-priced substances through various carbon resource systems (mineralization, microalgae, and liquefaction). In the case of the liquefaction process, when liquefaction is performed under high pressure/low temperature (20 atm and −20° C.) conditions, liquefied carbon dioxide (KRW 200,000/ton) may be produced.

In the conventional carbon dioxide capture and utilization process, there was a problem that an exhaust gas supply facility uses a process for cooling exhaust gas using cold water produced from an electric-driven chiller and cooling water produced from a cooling tower, and thus the electricity usage is large. There is a reboiler, which requires heat from the outside to maintain a constant temperature and smooth operation of a distillation process, at the bottom of a distillation tower that is operated to increase the purity of carbon dioxide in a carbon dioxide liquefaction process, and hot water or high-temperature steam should be supplied to the reboiler, and thus there is a problem that a boiler should be operated to supply hot water or high-temperature steam.

Further, when cooling is performed using cooling water produced from a cooling tower, the electricity usage of a combustion exhaust gas compressor may be increased because combustion exhaust gas is not cooled to a sufficiently low temperature, and when an electric-driven chiller is used, the electricity usage of the combustion exhaust gas compressor may be reduced, but a lot of electricity is consumed to operate the electric-driven chiller, and as a result, there is no electricity energy reduction effect. Therefore, improvements are required to reduce the electric energy usage in the process of capturing and utilizing carbon dioxide in the combustion exhaust gas.

District heating water that supplies district heating is heated to a supply temperature in a combined heat and power plant, then transmitted to a district heating supply system or supplied to and stored in a heat storage tank. In this process, the temperature (110° C.) of the district heating water produced from the combined heat and power plant is higher than the temperature (98° C.) when stored in the storage tank, and thus heat loss occurs when the district heating water is stored. This means that the heat obtained by combusting high-priced natural gas is not fully utilized and is lost to the atmosphere, resulting in energy loss.

### DETAILED DESCRIPTION OF INVENTION

### Technical Problem

An embodiment of the present invention is directed to providing a compact carbon dioxide capture and liquefaction system using high-temperature district heating water waste heat with respect to combustion exhaust gas of an urban power plant that is capable of reducing electric energy and heat energy used in a carbon dioxide capture and utilization process.

Further, an embodiment of the present invention is directed to providing a compact carbon dioxide capture and liquefaction system using high-temperature district heating water waste heat with respect to combustion exhaust gas of an urban power plant that is capable of preventing heat loss by utilizing waste heat generated during a process of storing district heating water in a heat storage tank, and utilizing the generated waste heat in a cooling process.

Objects of the present invention are not limited to the above-described objects and other objects that are not described may be clearly understood by those skilled in the art from the following descriptions.

### Technical Solution

A compact carbon dioxide capture and liquefaction system using high-temperature district heating water waste heat with respect to combustion exhaust gas of an urban power plant according to an embodiment of the present invention may include: a heat storage tank which is supplied with and stores district heating water heated in a combined heat and power plant; an absorption chiller configured to recover waste heat by performing heat exchange with the district heating water supplied to the heat storage tank and then supply the district heating water to the heat storage tank; a first cooler into which exhaust gas discharged from the combined heat and power plant is introduced and in which cooling water supplied from the absorption chiller and the exhaust gas are heat-exchanged; a capture device into which the exhaust gas discharged from the first cooler is introduced and which captures carbon dioxide contained in the exhaust gas; and a liquefaction device configured to liquefy the carbon dioxide captured in the capture device.

The compact carbon dioxide capture and liquefaction system may further include: a blower into which the exhaust gas discharged from the first cooler is introduced and which distributes the exhaust gas; a second cooler configured to cool the exhaust gas passing through the blower; and a storage tank configured to store the exhaust gas discharged from the second cooler.

The compact carbon dioxide capture and liquefaction system may further include a third cooler into which the exhaust gas discharged from the storage tank introduced after being compressed at high pressure and which cools the introduced exhaust gas, wherein the exhaust gas discharged from the third cooler is introduced into the capture device.

The compact carbon dioxide capture and liquefaction system may further include a fourth cooler configured to cool the exhaust gas discharged from the capture device and then supply the cooled exhaust gas to the liquefaction device.

Cold water discharged from the absorption chiller may be introduced into the second cooler, the third cooler, and the fourth cooler and heat-exchanged with the exhaust gas.

The cooling water heat-exchanged in and then discharged from the first cooler may be branched and supplied to a reboiler of a distillation tower requiring heat in the liquefaction device or may be recovered from the cooling tower.

The cooling water cooled by being supplied to the reboiler to supply heat may be combined with the cooling water recovered from the cooling tower, and the combined water may be recovered from the cooling tower.

The cooling water recovered from the cooling tower may be introduced into the absorption chiller and heat-exchanged in the absorption chiller, then a temperature thereof may be increased, and the cooling water may be supplied to the first cooler.

In the absorption chiller, a refrigerant may be heat-exchanged while circulating through an evaporator, an absorber, a regenerator, and a condenser.

### Advantageous Effects

According to an embodiment of the present invention, exhaust gas can be cooled by being heat-exchanged with cooling water that cools the exhaust gas in a first cooler and then cooled by cold water cooled through a refrigerant of an absorption chiller that utilizes waste heat, and thus the consumption of electric energy and heat energy can be significantly reduced.

Further, according to an embodiment of the present invention, by utilizing waste heat generated during a process of storing district heating water in a heat storage tank, heat loss can be prevented, and the generated waste heat can be utilized in a cooling process.

### DESCRIPTION OF DRAWINGS

FIG. 1 is a diagram illustrating a compact carbon dioxide capture and liquefaction system using high-temperature district heating water waste heat with respect to combustion exhaust gas of an urban power plant according to an embodiment of the present invention.

FIG. 2 is a diagram illustrating an example of an absorption chiller according to an embodiment of the present invention.

FIG. 3 is a diagram illustrating the flow of exhaust gas in a compact carbon dioxide capture and liquefaction system using high-temperature district heating water waste heat with respect to combustion exhaust gas of an urban power plant according to an embodiment of the present invention.

FIG. 4 is a diagram illustrating the flow of cooling water in a compact carbon dioxide capture and liquefaction system using high-temperature district heating water waste heat with respect to combustion exhaust gas of an urban power plant according to an embodiment of the present invention.

FIG. 5 is a diagram illustrating the flow of exhaust gas in a compact carbon dioxide capture and liquefaction system using high-temperature district heating water waste heat with respect to combustion exhaust gas of an urban power plant according to an embodiment of the present invention.

FIG. 6 is a diagram comparing power consumptions according to a compact carbon dioxide capture and liquefaction system using high-temperature district heating water waste heat with respect to combustion exhaust gas of an urban power plant according to an embodiment of the present invention.

FIG. 7 is a diagram comparing power usage percentages for each component of a compact carbon dioxide capture and liquefaction system using high-temperature district heating water waste heat with respect to combustion exhaust gas of an urban power plant according to an embodiment of the present invention.

### MODES OF THE INVENTION

While the present invention is open to various modifications and alternative forms, specific embodiments thereof are shown by way of example in the drawings and will herein be described in detail. However, it should be understood that there is no intent to limit the present invention to the particular forms disclosed, and on the contrary, the present invention is to cover all modifications, equivalents, and alternatives falling within the spirit and scope of the present invention. In the description of the present invention, when it is determined that detailed descriptions of related well-known configurations or functions unnecessarily obscure the gist of the present invention, the detailed descriptions thereof will be omitted.

It should be understood that, although the terms “first,” “second,” and the like may be used herein to describe various elements, the elements are not limited by these terms. These terms are only used to distinguish one element from another element.

The terminology used herein is for the purpose of describing particular embodiments only and is not intended to be limiting to the present invention. As used herein, the singular forms “a” and “an” are intended to also include the plural forms, unless the context clearly indicates otherwise. It will be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Further, throughout the specification, when an element is referred to as being “connected” to another element, this does not only mean that two or more elements are directly connected, but also that two or more elements are indirectly connected through other components, that two or more elements are electrically connected as well as physically connected, or that two or more elements are referred to by different names depending on location or function but are one.

Further, when an element is described as being formed “on (above)” or “under (below)” another element, the term “on (above)” or “under (below)” includes not only a case in which the two elements are in direct contact with each other, but also a case in which one or more other elements are (indirectly) disposed between the two elements. In addition, the term “on (above)” or “under (below)” includes a case in which another element is disposed in an upward direction or a downward direction with respect to one element.

Hereinafter, an embodiment of a compact carbon dioxide capture and liquefaction system using high-temperature district heating water waste heat with respect to combustion exhaust gas of an urban power plant according to the present invention will be described in detail with reference to the accompanying drawings, and in describing with reference to the accompanying drawings, the same or corresponding components are denoted by the same reference numerals regardless of reference numbers, and thus the description thereof will not be repeated.

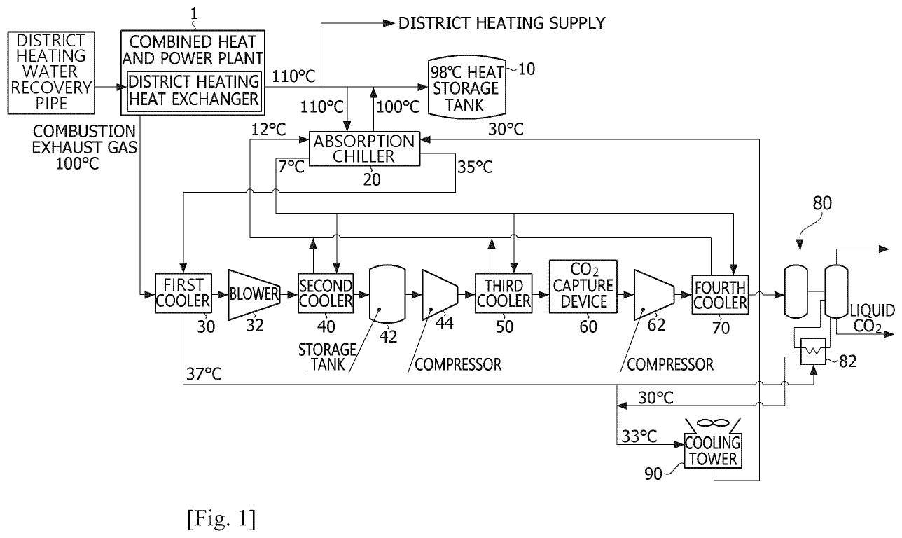

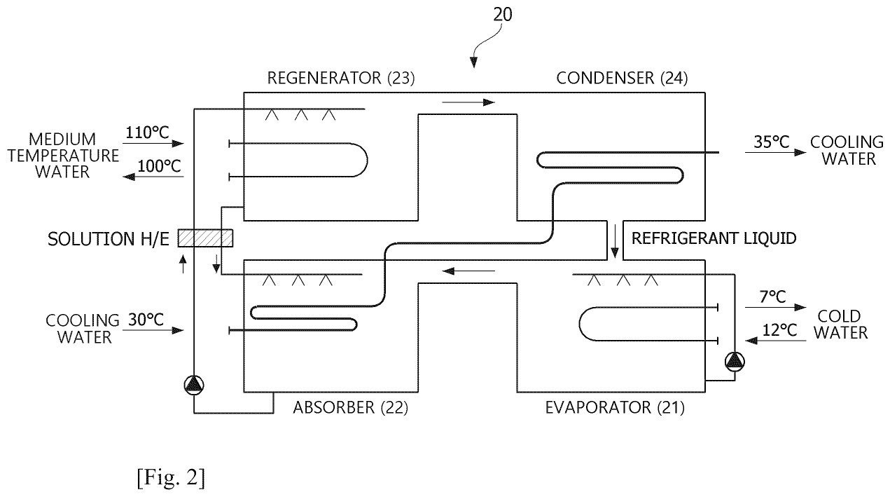

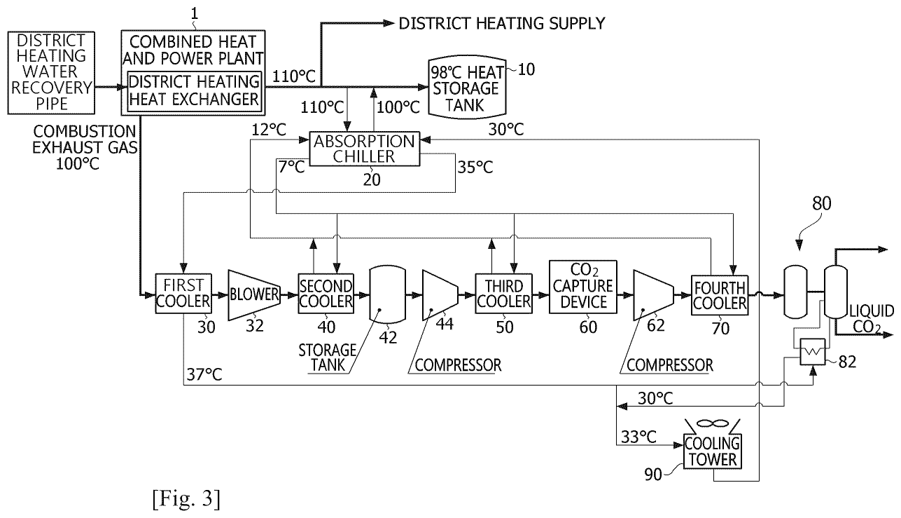

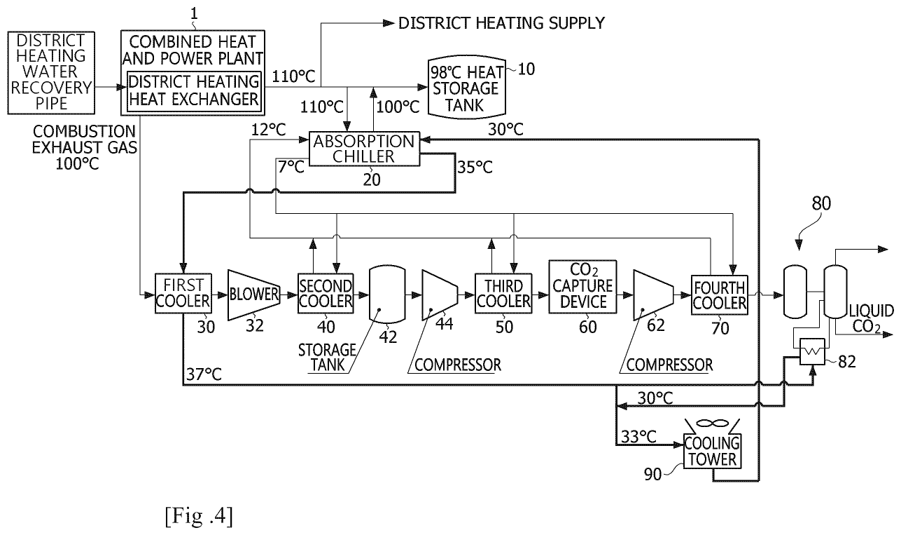

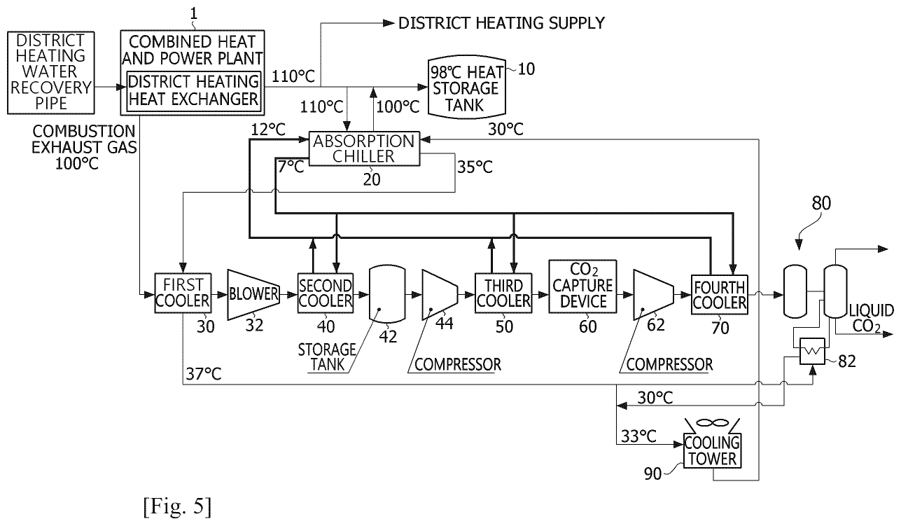

FIG. 1 is a diagram illustrating a compact carbon dioxide capture and liquefaction system using high-temperature district heating water waste heat with respect to combustion exhaust gas of an urban power plant according to an embodiment of the present invention, FIG. 2 is a diagram illustrating an example of an absorption chiller according to an embodiment of the present invention, FIG. 3 is a diagram illustrating the flow of exhaust gas in the compact carbon dioxide capture and liquefaction system using the high-temperature district heating water waste heat with respect to the combustion exhaust gas of the urban power plant according to an embodiment of the present invention, FIG. 4 is a diagram illustrating the flow of cooling water in the compact carbon dioxide capture and liquefaction system using the high-temperature district heating water waste heat with respect to the combustion exhaust gas of the urban power plant according to an embodiment of the present invention, and FIG. 5 is a diagram illustrating the flow of exhaust gas in the compact carbon dioxide capture and liquefaction system using the high-temperature district heating water waste heat with respect to the combustion exhaust gas of the urban power plant according to an embodiment of the present invention.

As illustrated in the drawings, the compact carbon dioxide capture and liquefaction system using the high-temperature district heating water waste heat with respect to the combustion exhaust gas of the urban power plant according to an embodiment of the present invention may include a heat storage tank 10 which is supplied with and stores district heating water heated in a combined heat and power plant 1, an absorption chiller 20 that recovers waste heat by performing heat exchange with the district heating water supplied to the heat storage tank 10 and then supplies the district heating water to the heat storage tank 10, a first cooler 30 into which exhaust gas discharged from the combined heat and power plant 1 is introduced and in which cooling water supplied from the absorption chiller 20 and the exhaust gas are heat-exchanged, a capture device 60 into which the exhaust gas discharged from the first cooler 30 is introduced and which captures carbon dioxide contained in the exhaust gas, and a liquefaction device 80 that liquefies the carbon dioxide captured in the capture device 60.

The combined heat and power plant 1 is a major heat source facility for collective energy supply and a power generation facility that supplies both heat energy and electric energy, and is a high-efficiency energy technology for recovering and utilizing waste heat (exhaust heat) which is inevitably generated in a process of producing electricity and generating power by receiving fuel such as natural gas (LNG) and ultra-low sulfur diesel fuel (low sulfur waxy residue (LSWR)).

The combined heat and power plant 1 heats the district heating water that supplies district heating to a supply temperature and then supplies the district heating water to a district heating supply system or supplies the district heating water to the heat storage tank 10 to store the district heating water. In this process, the temperature (110° C.) of the district heating water produced from the combined heat and power plant 1 is higher than the temperature (98° C.) when stored in the heat storage tank 10, and thus heat loss occurs when the district heating water is stored. In the present embodiment, the absorption chiller 20 is disposed to utilize the waste heat generated in the process of storing the district heating water in the heat storage tank 10.

The absorption chiller 20 recovers the waste heat by performing heat exchange with the district heating water supplied to the heat storage tank 10 and then supplies the recovered waste heat to the heat storage tank 10. At this time, the temperature of the district heating water is lowered from 110° C. to 100° C. Further, the absorption chiller 20 uses the district heating water waste heat to produce cold water which is required for cooling exhaust gas in a second cooler 30, a third cooler 50, and a fourth cooler 70.

Referring to FIG. 2, the absorption chiller 20 illustrated in this diagram is an application example of a basic absorption chiller to aid understanding, but the present invention is not limited thereto. In a regenerator of the absorption chiller 20, the temperature of the district heating water supplied as medium temperature water may be lowered from 110° C. to 100° C. through performing heat exchange with a refrigerant and then discharged. The refrigerant (water) of the absorption chiller 20 circulates through an evaporator 21, an absorber 22, a regenerator 23, and a condenser 24, and absorption liquid (lithium bromide) circulates through the absorber 22 and the regenerator 23. In this process, the refrigerant is cooled and condensed by cooling water, and the cooling water is introduced into the condenser at 30° C., then a temperature thereof is increased to 35° C., and the cooling water is discharged. Further, the cold water which is required for cooling the exhaust gas in the second cooler 30, the third cooler 50, and the fourth cooler 70 is introduced into the absorption chiller at 12° C., then a temperature thereof is lowered to 7° C. while passing through the evaporator 21, and then the cooling water is discharged.

In other words, the district heating water may be heat-exchanged so that the refrigerant (water) and the absorption liquid (lithium bromide) are separated while passing through the regenerator 23 of the absorption chiller 20, and the cooling water may be heat-exchanged with the refrigerant while moving from the absorber 22 of the absorption chiller 20 to the condenser 24.

Hereinafter, the flow of exhaust gas will be described with reference to FIG. 3. Combustion exhaust gas at 100° C. discharged from the combined heat and power plant 1 may be introduced into the first cooler 30, and the exhaust gas may be cooled by being heat-exchanged with the cooling water supplied from the absorption chiller 20. In this case, the cooling water is supplied at 35° C. to cool the exhaust gas and then discharged at 37° C.

The exhaust gas discharged from the first cooler 30 is distributed by the blower 32 and then introduced into the second cooler 40. In the second cooler 40, as described above, the exhaust gas is cooled by being heat-exchanged with the cold water, introduced into a storage tank 42, and temporarily stored. The exhaust gas temporarily stored in the storage tank 42 is compressed at high pressure by a compressor 44 and then introduced into the third cooler 50. In the third cooler 50, the exhaust gas is cooled by being heat-exchanged with the cold water as in the second cooler 40.

The exhaust gas discharged from the third cooler 50 may be introduced into the capture device 60 so that carbon dioxide contained in the exhaust gas may be captured. The exhaust gas discharged from the capture device 60 is re-compressed at high pressure in a compressor 62 and then introduced into the fourth cooler 70. In the fourth cooler 70, the exhaust gas is cooled by being heat-exchanged with the cold water as in the third cooler 50.

In addition, the exhaust gas discharged from the fourth cooler 70 may be introduced into the liquefaction device 80, and then the carbon dioxide may be liquefied so that high-purity liquid carbon dioxide may be produced.

Hereinafter, the flow of cooling water will be described with reference to FIG. 4. The cooling water supplied from the absorption chiller 20 is introduced into the first cooler 30, is heat-exchanged, and then is discharged at 37° C. The cooling water discharged from the first cooler 30 may be branched and supplied to a reboiler 82 of a distillation tower requiring heat in the liquefaction device 80 or may be recovered from a cooling tower 90.

The cooling water supplied to the reboiler 82 may be heat-exchanged such that a temperature thereof becomes 30° C., then combined with the cooling water recovered to the cooling tower 90, and the combined water is recovered from the cooling tower 90. In this case, the cooling water that is recovered directly to the cooling tower 90 has a temperature of 37 ° C. and may be combined with the 30° C. cooling water discharged from the reboiler 82 to become 33° C. and recovered from the cooling tower 90. In the cooling tower 90, the cooling water may be cooled to 30° C. and supplied to the absorption chiller 20.

In this way, in the present embodiment, in the absorption chiller 20, the temperature of the cooling water is increased while moving from the absorber 22 to the condenser 24 using the district heating water waste heat, and then primary cooling the exhaust gas is possible, and thus electric energy and heat energy consumption can be reduced.

Hereinafter, the flow of cold water will be described with reference to FIG. 5. The temperature of the cold water becomes 7° C., and the cold water is discharged from the absorption chiller 20 and then introduced into each of the second cooler 30, the third cooler 50, and the fourth cooler 70 to cool the exhaust gas. The cold water heat-exchanged with the exhaust gas may be discharged at 12° C., introduced into the evaporator 21 of the absorption chiller 20, and then cooled to 7° C. by a refrigerant.

In this way, in the present embodiment, the exhaust gas from the second cooler 30, third cooler 50, and fourth cooler 70 may be cooled by being heat-exchanged with the cold water produced from the absorption chiller 20. Therefore, through a process of highly efficiently cooling exhaust gas using waste heat, electric energy and heat energy may be reduced compared to conventional electric-driven chillers.

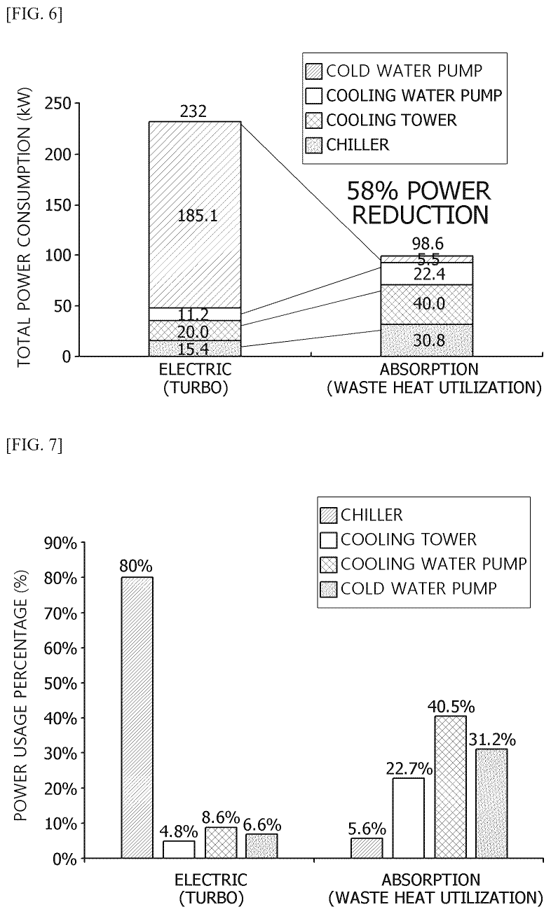

FIG. 6 is a diagram comparing power consumptions according to a compact carbon dioxide capture and liquefaction system using high-temperature district heating water waste heat with respect to combustion exhaust gas of an urban power plant according to an embodiment of the present invention, and FIG. 7 is a diagram comparing power usage percentages for each component of the compact carbon dioxide capture and liquefaction system using the high-temperature district heating water waste heat with respect to the combustion exhaust gas of the urban power plant according to an embodiment of the present invention.

Referring to FIG. 6, the conventional carbon dioxide capture and liquefaction process using electricity has a problem that an exhaust gas inlet temperature is 100° C. and a significant amount of electric energy is consumed to cool exhaust gas to 35° C. or lower using a cooling tower and an electric turbo chiller (a type of electric-driven chiller). When 10,500 Nm3/hr of convention supply combustion exhaust gas is treated through a compact membrane capture process and a liquefaction process to produce liquefied carbon dioxide concentrated from 5% before treatment to 99% after treatment, a total of 232 kW of power is consumed by a 300RT-class electric turbo chiller, cooling tower, cooling water pump, and cold water pump, and in particular, 80% of the total power is consumed by the electric turbo chiller, consuming a total of 185 kW.

However, according to the present embodiment in which the district heating water waste heat of the heat storage tank 10 discharged into the air is utilized, a total electricity usage for operating the absorption chiller 20 and auxiliary facilities (cooling tower, pump, etc.) is 98.6 kW, and among the total electricity usage, the amount of electricity consumed by a main body of the absorption chiller 20 is only 5.5 kW, which is 5.6% of the total electricity consumption and is only 3% of the electricity consumption of a conventional electric turbo chiller, and thus there is a clear electric energy reduction effect.

Referring to FIG. 7, for the entire process, when the electric energy consumption of electric (turbo) system is 100% (232 kW), the total electric energy consumption of the absorption system according to the present embodiment in which district heating water waste heat is utilized is 42% (98.6 kW), and the reduction rate is about 58%, confirming a clear energy reduction effect.

Therefore, when the components of the system are identically formed as a chiller, a cooling tower, a cooling water pump, and a cold water pump, it was found that the electric turbo chiller of the electric (turbo) system consumes 80% or more of the power usage of the entire system, but, among the entire components of the absorption system utilizing waste heat, the absorption chiller 20 consumes only 5.6%, which is the smallest amount.

As seen above, according to the present embodiment, by utilizing the district heating water waste heat that is discarded during the process of storing in the heat storage tank 10, waste heat of the heat storage tank 10 is recovered by the regenerator 23, (110→100° C.) according to the flow of the refrigerant of the absorption chiller 20, and then supplied to the heat storage tank 10 at 100° C. or lower, thereafter, as passing through the absorber 22 and condenser 24 of the absorption chiller 20, the temperature of the cooling water changes (30→35° C.), and the 35° C. cooling water discharged from the absorption chiller 20 may be used for primary cooling in the first cooler 30, and thereafter, the exhaust gas may be cooled in the second cooler 30, third cooler 50, and fourth cooler 70 by utilizing the cold cooling water heat-exchanged in the evaporator 21 (12→7° C.) stage, and thus a clear electric energy and heat energy reduction effect can be obtained through a high-efficiency cooling process.

While the present invention has been described with reference to specific embodiments, it will be understood by those skilled in the art that various changes and modifications may be made without departing from the spirit and scope of the present invention as defined by the appended claims.

### REFERENCE NUMERALS

1: combined heat and power plant
10: heat storage tank
20: absorption chiller
21: evaporator
22: absorber
23: regenerator
24: condenser
30: first cooler
32: blower
40: second cooler
42: storage tank
44: compressor
50: third cooler
60: capture device
62: compressor
70: fourth cooler
80: liquefaction device
82: reboiler
90: cooling

1. A compact carbon dioxide capture and liquefaction system using high-temperature district heating water waste heat with respect to combustion exhaust gas of an urban power plant, the system comprising:
a heat storage tank which is supplied with and stores district heating water heated in a combined heat and power plant;
an absorption chiller configured to recover waste heat by performing heat exchange with the district heating water supplied to the heat storage tank and then supply the district heating water to the heat storage tank;
a first cooler into which exhaust gas discharged from the combined heat and power plant is introduced and in which cooling water supplied from the absorption chiller and the exhaust gas are heat-exchanged;
a capture device into which the exhaust gas discharged from the first cooler is introduced and which captures carbon dioxide contained in the exhaust gas; and
a liquefaction device configured to liquefy the carbon dioxide captured in the capture device.

2. The compact carbon dioxide capture and liquefaction system of claim 1, further comprising:
a blower into which the exhaust gas discharged from the first cooler is introduced and which distributes the exhaust gas;
a second cooler configured to cool the exhaust gas passing through the blower; and
a storage tank configured to store the exhaust gas discharged from the second cooler.

3. The compact carbon dioxide capture and liquefaction system of claim 2, further comprising a third cooler into which the exhaust gas discharged from the storage tank is introduced after being compressed at high pressure and which cools the introduced exhaust gas,
wherein the exhaust gas discharged from the third cooler is introduced into the capture device.

4. The compact carbon dioxide capture and liquefaction system of claim 3, further comprising a fourth cooler configured to cool the exhaust gas discharged from the capture device and then supply the cooled exhaust gas to the liquefaction device.

5. The compact carbon dioxide capture and liquefaction system of claim 4, wherein cold water discharged from the absorption chiller is introduced into the second cooler, the third cooler, and the fourth cooler and heat-exchanged with the exhaust gas.

6. The compact carbon dioxide capture and liquefaction system of claim 1, wherein the cooling water heat-exchanged in and then discharged from the first cooler is branched and supplied to a reboiler of a distillation tower requiring heat in the liquefaction device or is recovered from the cooling tower.

7. The compact carbon dioxide capture and liquefaction system of claim 6, wherein the cooling water cooled by being supplied to the reboiler to supply heat is combined with the cooling water recovered from the cooling tower, and the combined water is recovered from the cooling tower.

8. The compact carbon dioxide capture and liquefaction system of claim 7, wherein the cooling water recovered from the cooling tower is introduced into the absorption chiller and heat-exchanged in the absorption chiller, then a temperature thereof is increased, and the cooling water is supplied to the first cooler.

9. The compact carbon dioxide capture and liquefaction system of claim 1, wherein, in the absorption chiller, a refrigerant is heat-exchanged while circulating through an evaporator, an absorber, a regenerator, and a condenser.

10. The compact carbon dioxide capture and liquefaction system of claim 9, wherein the district heating water is heat-exchanged with the refrigerant while passing through the regenerator, and the cooling water is heat-exchanged with the refrigerant while moving from the absorber to the condenser.
